(19) United States
(12) Patent Application Publication
(10) Pub. No.: US 2022/0282523 A1
(43) Pub. Date: Sep. 8, 2022

(54) FOOT RECEIVING PLATFORM

(71) Applicant: Hudson Albert, Kenosha, WI (US)

(72) Inventor: Hudson Albert, Kenosha, WI (US)

(21) Appl. No.: 17/194,266

(22) Filed: Mar. 7, 2021

(51) Int. Cl. E05B 1/00

(52) U.S. Cl. CPC E05B 1/0053; E05B 1/0015

(57) ABSTRACT

A foot receiving platform, including an attachment plate, including a first section removably connected to at least a portion of a first side of a door leaf, and a second section removably connected to at least a portion of a second side of the door leaf, and a pivoting surface movably disposed on at least a portion of the first section and the second section to receive a foot of a user thereon.

### BACKGROUND

### 1. Field

The present general inventive concept relates generally to a platform, and particularly, to a foot receiving platform.

### 2. Description of the Related Art

In today's society, there is a great necessity to practice effective safety protocols that decrease exposure to disease causing agents. More specifically, a global pandemic due to coronavirus disease 2019 (COVID-19) has radically changed social behaviors.

The use of a door handle on a door and/or other types of hardware, such as railings require touch by a user's hands. Unfortunately, touching of the door handle and/or any other surface is a common vector of viral and/or bacterial transmission. However, most conventional doors still use door handles that require hands to move the door.

Therefore, there is a need for a foot receiving platform connected to a door facilitate moving the door without the user's hands.

### SUMMARY

The present general inventive concept provides a foot receiving platform.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a foot receiving platform, including an attachment plate, including a first section removably connected to at least a portion of a first side of a door leaf, and a second section removably connected to at least a portion of a second side of the door leaf, and a pivoting surface movably disposed on at least a portion of the first section and the second section to receive a foot of a user thereon.

The attachment plate may further include a recessed surface disposed on at least a portion of the first section to receive the pivoting surface therein.

The pivoting surface may move from retracted within the recessed surface in a first position to at least partially extended away from the recessed surface in a second position, and moves from extended away from the recessed surface in the second position to retracted within the recessed surface in the first position.

The second section may be perpendicularly disposed away from the first section with respect to a lateral direction.

The pivoting surface may include a foot receiving portion disposed on at least a portion of a first side of the pivoting surface, and a door stopping portion disposed on at least a portion of a second side of the pivoting surface opposite with respect to the first side of the pivoting surface to absorb a force of impact by an external object thereon.

The foot receiving platform may further include a movement resistant coating disposed on at least a portion of the second section to resist movement of the door leaf by increasing friction against a ground surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric view of a foot receiving platform in an extended position, according to an exemplary embodiment of the present general inventive concept; and

FIG. 2 illustrates a zoomed in view of the foot receiving platform in a retracted position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Foot Receiving Platform 100

Attachment Plate 110

First Section 111

Second Section 112

Recessed Surface 113

Pivoting Surface 120

Foot Receiving Portion 121

Door Stopping Portion 122

Hinge 123

Fasteners 130

Movement Resistant Coating 140

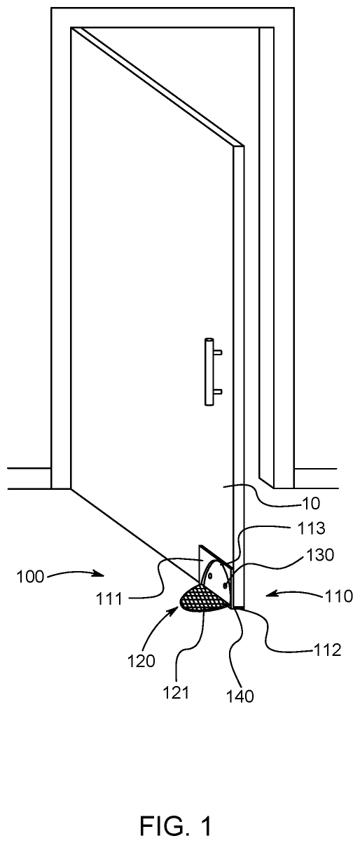

FIG. 1 illustrates an isometric view of a foot receiving platform 100 in an extended position, according to an exemplary embodiment of the present general inventive concept.

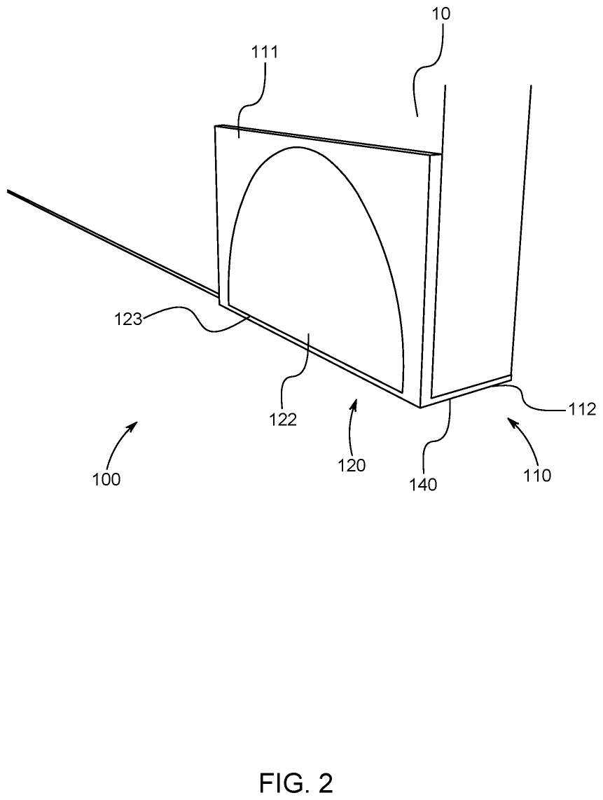

FIG. 2 illustrates a zoomed in view of the foot receiving platform 100 in a retracted position, according to an exemplary embodiment of the present general inventive concept.

The foot receiving platform 100 may be constructed from at least one of metal, plastic, wood, and rubber, etc., but is not limited thereto.

The foot receiving platform 100 may include an attachment plate 110, a pivoting surface 120, a plurality of fasteners 130, and a movement resistant coating 140, but is not limited thereto.

The attachment plate 110 may include a first section 111, a second section 112, and a recessed surface 113, but is not limited thereto.

The first section 111 may be removably connected to at least a portion of a first side of a door leaf 10, such as a corner of a bottom portion of an inner surface and/or an outer surface of the door leaf 10.

The second section 112 may be removably connected to at least a portion of a second side of the door leaf 10, such as a bottom surface of the door leaf 10 near a ground surface. Additionally, the second section 112 may be perpendicularly disposed away from the first section 111 with respect to a lateral direction.

The recessed surface 113 may be disposed on at least a portion of the first section 111. The recessed surface 113 may be recessed with respect to an outer surface of the first section 111.

Referring to FIGS. 1 and 2, the pivoting surface 120 is illustrated to have a half circular shape. However, the pivoting surface 120 may be rectangular, circular, conical, triangular, pentagonal, hexagonal, heptagonal, octagonal, or any other shape known to one of ordinary skill in the art, but is not limited thereto.

The pivoting surface 120 may include a foot receiving portion 121, a door stopping portion 122, and a hinge 123, but is not limited thereto.

Referring again to FIG. 1, the foot receiving portion 121 may be disposed on at least a portion of a first side of the pivoting surface 120 to receive a foot of a user thereon. Additionally, the foot receiving portion 121 may provide a friction surface to resist movement of the foot away from the foot receiving portion 121. More specifically, the foot receiving portion 121 may include a solid smooth surface (e.g., rubber), a bubbled surface having protrusions extending therefrom, a knurled surface, a mesh, an adhesive, and/or a semi-adhesive surface, etc., but is not limited thereto.

Referring again to FIG. 2, the door stopping portion 122 may be disposed on at least a portion of a second side of the pivoting surface 120 opposite with respect to the first side of the pivoting surface 120. Moreover, the door stopping portion 122 may include a cushion. As such, the door stopping portion 122 may prevent damage to the door leaf 10 in response to contact with an external object, such as a wall due to the cushion. In other words, the door stopping portion 122 may operate as a door stopper by absorbing a force of impact thereon.

The pivoting surface 120 may be movably (i.e. pivotally) disposed on at least a portion of the first section 111 and/or the second section 112 via the hinge 123. Referring again to FIGS. 1 and 2, additionally, the pivoting surface 120 may move from retracted in a first position to at least partially extended in a second position. Conversely, the pivoting surface may move from extended in the second position to retracted in the first position.

The hinge 123 may be spring biased to move from the second position to the first position. Furthermore, the hinge 123 may use a lock to prevent movement of the pivoting surface 120 in the first position and/or the second position. Also, while in the first position, the pivoting surface 120 may be depressed to extract the pivoting surface 120 from the recessed surface 113, such that the pivoting surface 120 may move to the second position.

As such, the recessed surface 113 may receive the pivoting surface 120 therein. As such, the recessed surface 113 may have a shape similar to the pivoting surface 120, such as a half circle.

The plurality of fasteners 130 may include a bolt, a screw, a nail, a washer, a nut, a clasp, a magnet, an adhesive, and/or any combination thereof, but is not limited thereto.

The plurality of fasteners 130 may be removably connected to at least a portion of the first section 111, the second section 112, and/or the recessed surface 113. As such, the plurality of fasteners 130 may removably connect the attachment plate 110 to the door leaf 10.

The movement resistant coating 140 may be constructed of rubber and/or plastic. The movement resistant coating 140 may be disposed on at least a portion of the second section 112. Accordingly, the movement resistant coating 140 may increase friction of the door leaf 10 against the ground surface to reduce a rate of movement. As such, the movement resistant coating 140 may resist movement of the door leaf 10, such that the door leaf 10 may move slowly by increasing friction against the ground surface.

Therefore, the foot receiving platform 100 may facilitate movement of the door leaf 10 without using hands of the user. Additionally, the foot receiving platform 100 may prevent damage to the door leaf 10 by absorbing an impact against the wall.

The present general inventive concept may include a foot receiving platform 100, including an attachment plate 110, including a first section 111 removably connected to at least a portion of a first side of a door leaf 10, and a second section 112 removably connected to at least a portion of a second side of the door leaf 10, and a pivoting surface 120 movably disposed on at least a portion of the first section 111 and the second section 112 to receive a foot of a user thereon.

The attachment plate 110 may further include a recessed surface 113 disposed on at least a portion of the first section 111 to receive the pivoting surface therein.

The pivoting surface 120 may move from retracted within the recessed surface 113 in a first position to at least partially extended away from the recessed surface 113 in a second position, and moves from extended away from the recessed surface 113 in the second position to retracted within the recessed surface 113 in the first position.

The second section 112 may be perpendicularly disposed away from the first section 111 with respect to a lateral direction.

The pivoting surface 120 may include a foot receiving portion 121 disposed on at least a portion of a first side of the pivoting surface 120, and a door stopping portion 122 disposed on at least a portion of a second side of the pivoting surface 120 opposite with respect to the first side of the pivoting surface 120 to absorb a force of impact by an external object thereon.

The foot receiving platform 100 may further include a movement resistant coating 140 disposed on at least a portion of the second section 112 to resist movement of the door leaf 10 by increasing friction against a ground surface.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A foot receiving platform, comprising:
an attachment plate, comprising:
a first section removably connected to at least a portion of a first side of a door leaf, and
a second section removably connected to at least a portion of a second side of the door leaf; and
a pivoting surface movably disposed on at least a portion of the first section and the second section to receive a foot of a user thereon.

2. The foot receiving platform of claim 1, wherein the attachment plate further comprises:
a recessed surface disposed on at least a portion of the first section to receive the pivoting surface therein.

3. The foot receiving platform of claim 2, wherein the pivoting surface moves from retracted within the recessed surface in a first position to at least partially extended away from the recessed surface in a second position, and moves from extended away from the recessed surface in the second position to retracted within the recessed surface in the first position.

4. The foot receiving platform of claim 1, wherein the second section is perpendicularly disposed away from the first section with respect to a lateral direction.

5. The foot receiving platform of claim 1, wherein the pivoting surface comprises:
a foot receiving portion disposed on at least a portion of a first side of the pivoting surface; and
a door stopping portion disposed on at least a portion of a second side of the pivoting surface opposite with respect to the first side of the pivoting surface to absorb a force of impact by an external object thereon.

6. The foot receiving platform of claim 1, further comprising:
a movement resistant coating disposed on at least a portion of the second section to resist movement of the door leaf by increasing friction against a ground surface.
